(19) United States
(12) Patent Application Publication
(10) Pub. No.: US 2025/0033281 A1
(43) Pub. Date: Jan. 30, 2025

(54) DUAL HEATER CARTRIDGE HEATER BLOCK AND METHODS THEREOF

(71) Applicant: Anthony Homen, Ceres, CA (US)

(72) Inventor: Anthony Homen, Ceres, CA (US)

(21) Appl. No.: 18/780,948

(22) Filed: Jul. 23, 2024

Related U.S. Application Data
(60) Provisional application No. 63/528,867, filed on Jul. 25, 2023.

(51) Int. Cl. B29C 64/295; B29C 64/118; B29C 64/393; B33Y 10/00; B33Y 30/00; B33Y 50/02

(52) U.S. Cl. CPC B29C 64/295; B29C 64/118; B29C 64/393; B33Y 10/00; B33Y 30/00; B33Y 50/02; B29K 2995/0013

(57) ABSTRACT

A heater block having a dual heater cartridge configuration that may be operable to uniformly heat a nozzle, the heater block positioning two heater cartridges on opposite sides of the nozzle with at least one thermistor between them. The heater block may be operable to be incorporated in the hot end assembly of fused deposit modeling three-dimensional printer.

### PRIORITY CLAIM

This application claims the benefit of U.S. Provisional Application No. 63/528,867 filed on Jul. 25, 2023 which is incorporated herein by this reference in its entirety.

### FIELD OF THE INVENTION

The present invention relates generally to the field of additive manufacturing, and more specifically to a heater block for use in a 3D printer hot end assembly. More particularly, the present invention provides heat through a dual heater cartridge heater block that may be operable to uniformly heat a nozzle.

### BACKGROUND OF THE INVENTION

Three-dimensional (3D) printing is a rapidly evolving technology that allows for the creation of physical objects from digital models. One common type of 3D printing, known as fused deposition modeling (FDM), involves heating a filament of thermoplastic material until it melts, and then extruding it layer by layer to build up the desired object. The heating of the filament is typically accomplished using a component known as a hot end assembly, which includes a heater block and a heater. The heater block is a piece of metal that is designed to evenly distribute the heat from the heater to the filament. The heater is typically a resistive element that generates heat when an electric current is passed through it.

Existing heater blocks typically use one heater cartridge to generate the necessary heat. The heater cartridge is typically positioned on one side of the nozzle and provides biased heat distribution that is non-uniform and provides inconsistent heating to the filament thereby leading to clogs and delays in completing printing projects. There is therefore a need for a heater block design that provides optimal heat distribution.

### SUMMARY OF THE INVENTION

The present invention provides a novel heater block for a hot end assembly for a 3D printer that may be operable to provide an even heat distribution. In embodiments of the invention, the heater block is configured to receive two heater cartridges that are positioned on opposite sides of the heater block with at least one thermistor between them. The dual heater cartridge configuration helps maintain consistent heat in the heater block, and provides for even heating distribution to the filament before extrusion thereby improving print quality, accuracy and speed while reducing delays.

It is an aspect of the present invention to provide a heater block for use in a hot end assembly of a 3D printer, the heater block may include: a body made from a thermally conductive material configured to evenly distribute heat throughout the body; a first and second aperture extending through the body for receiving first and second heater cartridges, the first and second aperture securing the heater cartridges in thermal contact with the body to heat the body; a third aperture extending through the body for receiving at least one thermistor, the third aperture positioned such that when the thermistor is inserted, it may be capable of accurately measuring the temperature of the body; a central conduit extending through the body for receiving a heat break on a top surface of the body, the central conduit configured to guide a filament from an extruder to a nozzle secured to a bottom surface of the body; and wherein the nozzle may be in thermal contact with the body and positioned between the first and second heater cartridge, and may be operable to provide heat for melting the filament. The first and second aperture may extend from one side of the body to the opposite side of the body. The body may have a top surface with a pair of threaded holes, each corresponding to the center of the first and second apertures on a top surface. The threaded holes may be operable to receive a fastener to secure the heater cartridges. The first and second heater cartridges may have a heating output monitored by at least one thermistor. The thermistor may be two thermistors, each positioned substantially adjacent to one of the heater cartridges, where the two thermistors may be operable to measure the temperature output of each of the first and second heater cartridges independently. The central conduit may be operable to receive the heat break on the top surface and the nozzle on the bottom such that the heat break and nozzle are inline.

It is an aspect of the present invention to provide a method of using a heater block in the hot end assembly of a 3D printer, the method comprising the steps of: first, inserting a first heater cartridge into the first aperture of the heater block, where the first heater cartridge may be in thermal contact with the heater block, inserting a second heater cartridge into a second aperture of the heater block, where the second heater cartridge may be in thermal contact with the heater block. This may be followed by inserting at least one thermistor into a third aperture of the heater block, adjacent to the first and second apertures, where the thermistor may be operable to measure the temperature of the heater block; providing a central conduit in the heater block and inserting a heat break into the central conduit on a top surface of the heater block and inserting a nozzle into the central conduit on a bottom surface of the heater block, where the heat break and the nozzle are inline and may be in thermal contact with the heater block; and applying electrical power to the first and second heater cartridges to generate heat, thereby heating the heater block and nozzle. The first and second heater cartridges may each have a distal end having wiring that may be in communication with a controller and may be operable to convert electrical power to heat. The central conduit may be positioned between the first and second heater cartridges and may be operable to provide a uniform heat distribution to each side of the nozzle. The method may further include the steps of monitoring the temperature of the heater block with at least one thermistor and adjusting the power to each of the heater cartridges to maintain a desired temperature, and feeding a filament through the heat break into the nozzle, where the heat from the heater block melts the filament and extruding a melted filament through the nozzle onto a build plate of the 3D printer to create a 3D object. The thermistor may be operable to monitor the temperature of the entire heater block and may be operable to provide temperature data to a controller for modifying the temperature of the first and second heater cartridges. The at least one thermistor, may be two thermistors, each positioned adjacent to one of the first and second apertures, and may be operable to measure the temperature of the heater block and the variation of a temperature output from each of the heater cartridges independently. The variation of the temperature output from a first and second heater cartridges may be operably adjusted by the controller to provide a uniform heat distribution in the heater block.

It is another aspect of the present invention to provide a novel hot end assembly for a 3D printer; the hot end assembly may include: a nozzle through which a filament may be extruded, a heater block having a central conduit securing a nozzle on a bottom surface, having a first and second heater cartridge aperture on opposite sides of the central conduit, wherein the nozzle may be in thermal contact with the heater block, a heat break connecting the heater block to a heat sink, the heat break being secured to a top surface of the heater block and may be operable to guide the filament from an extruder to the nozzle, a first heater cartridge secured to the first heater cartridge aperture and a second heater cartridge secured to the second heater cartridge aperture, each of the heater cartridges may be operable to heat the heater block, and at least one thermistor for monitoring a temperature of the heater block. The thermistor may be adjacent to the two apertures. The hot end assembly may include a guide tube secured to a top end of the heat break, which may be operable to route the filament into the hot end. The nozzle may have a diameter of any suitable size, and in some embodiments may be 0.4 mm. The guide tube may be constructed from PTFE and may have a low friction and high heat resistance. Each of the first and second heater cartridges may be independently in electrical communication with a controller and may be each operable to convert electric current into heat. Each of the first and second heater cartridges may be monitored by two thermistors, each positioned adjacent to the heater cartridges in the heater block and may be operable to measure the temperature difference from each heater cartridge and calibrate the temperature for a uniform temperature distribution.

Further aspects and embodiments will be apparent to those having skill in the art from the description and disclosure provided herein.

It is an object of the present invention to provide a heater block that may be operable to receive a first and second heater cartridge in order to maintain consistency and uniformity of heat distribution in the heater block, and thereby to the nozzle.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a top left environmental view of an assembled heater block incorporated into a hot end assembly, according to an embodiment of the present invention.

FIG. 2 provides an exploded view of a hot end assembly, according to an embodiment of the present invention.

FIG. 3 provides an isometric front bottom left side view of a heater block, according to an embodiment of the present invention.

FIG. 4 provides an isometric rear top right side view of a heater block, according to an embodiment of the present invention.

FIG. 5 provides an isometric rear top left view of a heater block, according to another embodiment of the present invention.

FIG. 6 provides a top left environmental view of an assembled heater block incorporated into a hot end assembly, according to another embodiment of the present invention.

FIG. 7 is a photographic view of a top of an embodiment of the present invention.

FIG. 8 is a photographic view of a bottom of an embodiment of the present invention.

FIG. 9 is a photographic view of a left side of an embodiment of the present invention.

FIG. 10 is a photographic view of a right side of an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

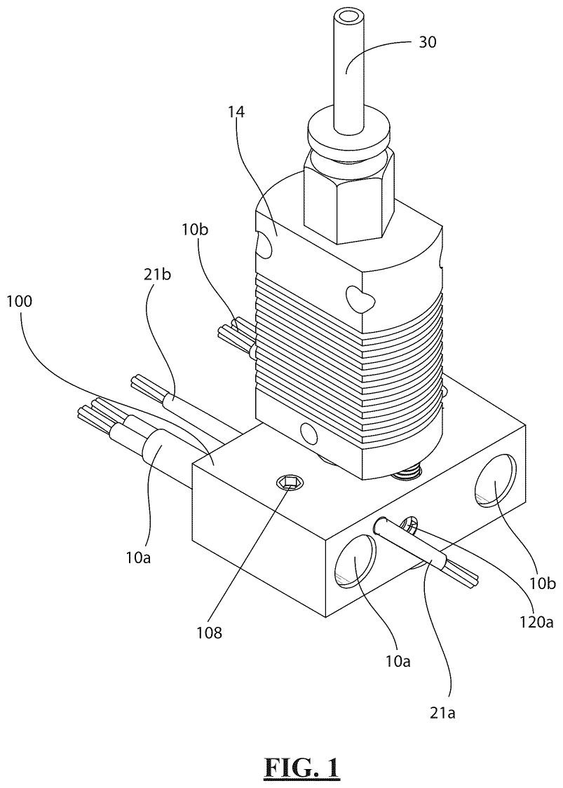

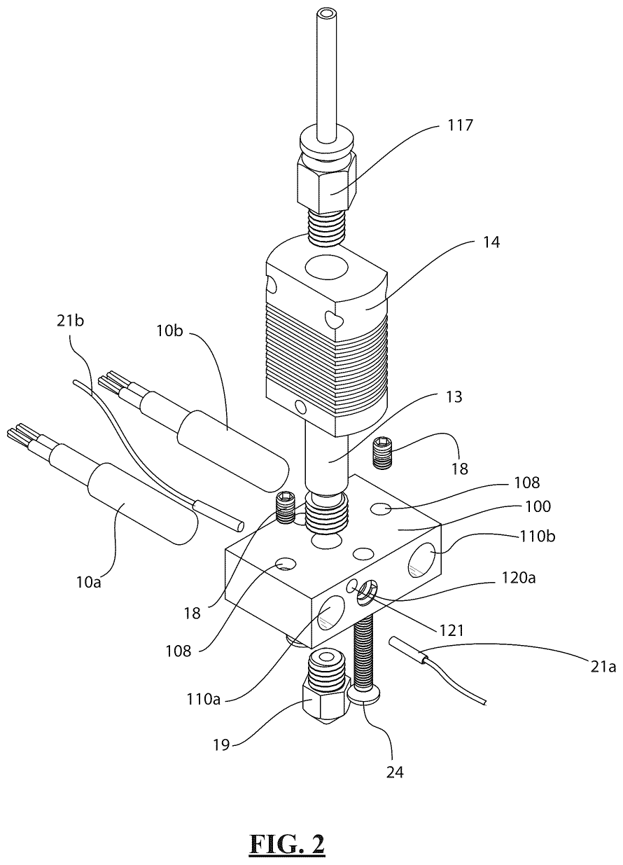

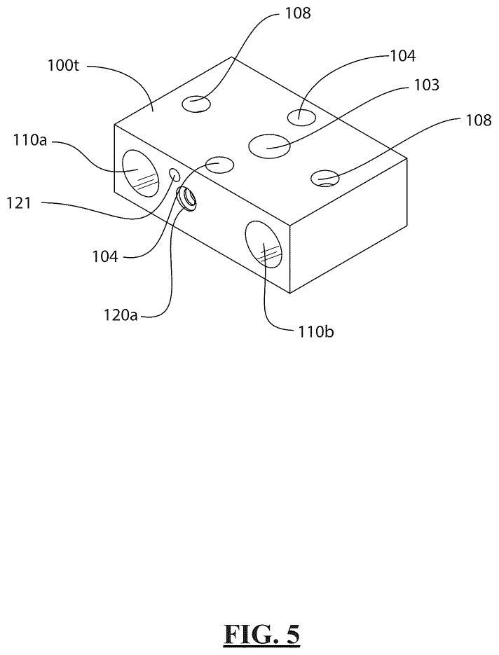

The present invention concerns a 3D printer hot end assembly. Referring to the illustrated exemplary embodiment shown in FIGS. 1-6, it is seen that a hot end assembly is provided that may include a nozzle 19, a heater block 100, a heat breaker 13 (e.g., heat throat), heater cartridges (10a, 10b), at least one thermistor or a pair of thermistors 21a, 21b (cartridge thermistors), a heat sink 14, and a guide tube 117. The heater block 100 of the illustrated embodiment may include a dual heating system that may be operable to receive a first and second heater cartridge (10a, 10b) and may be in electronic communication with a 3D printer control system (not shown). The heater block 100 may position the nozzle 19 near the center of the heater block, and the heater cartridges (10a, 10b) may be positioned on each side of the nozzle providing consistent heat to the nozzle and rapid and uniform heating to the nozzle, thereby improving the flow of filament through the nozzle head. The embodiment of FIGS. 1 and 2 illustrates the use of two cartridge thermistors (21a, 21b).

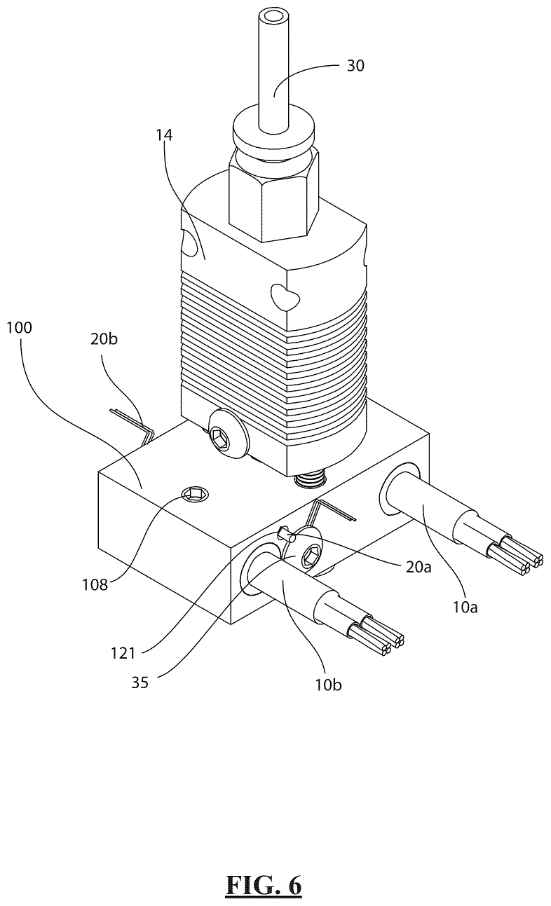

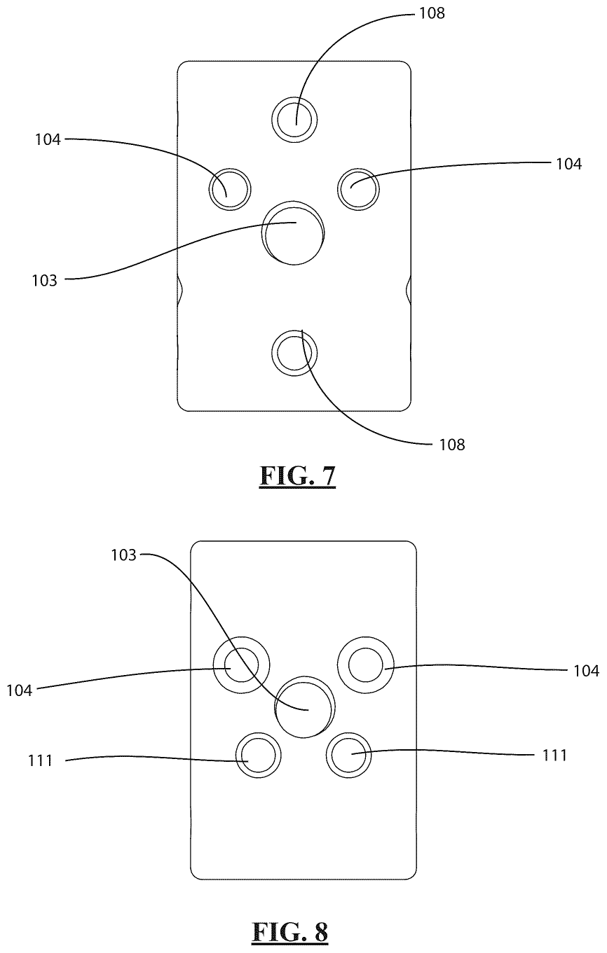

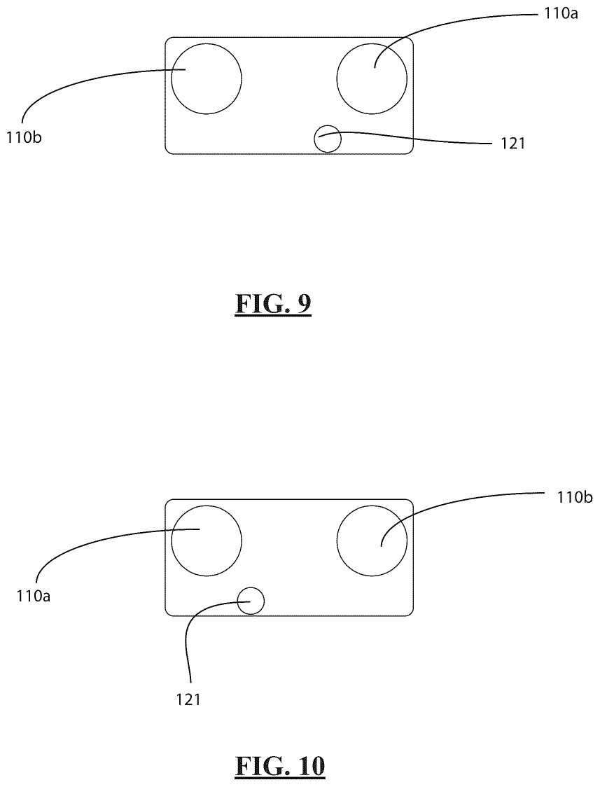

It is to be appreciated that in other embodiments, such as that shown in FIG. 6, two wire thermistors (20a, 20b) may be used. Also, different combinations of thermistors may be provided. For example and without limitation a single wire thermistor 20a or 20b may be provided; two wire thermistors 20a and 20b may be provided; a single cartridge thermistor 21a or 21b may be provided; two cartridge thermistors 21a and 21b may be provided. In other embodiments mixtures of wire and cartridge thermistors may be provided, for example and without limitation, a single wire thermistor 20a or 20b may be provide with a single cartridge thermistor 21a or 21b.

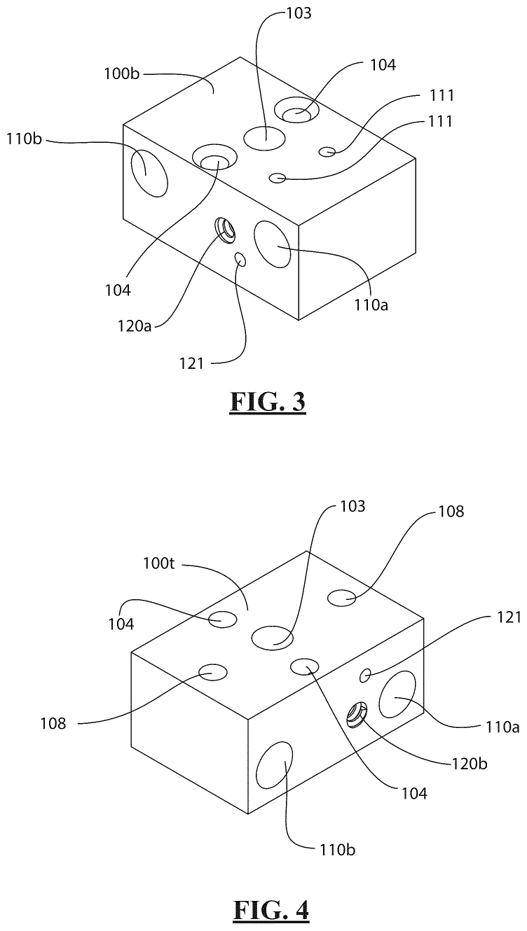

The heater block 100 as illustrated in the embodiment of FIGS. 3-5 may include a top surface 100t, a bottom surface 100b, a first conduit 110a extending through block 100, a second conduit 110b extending through block 100. Conduits 110a and 110b may be operable to receive the heater cartridges 10a and 10b respectively (not shown in FIGS. 3-5). The exemplary heater block shown in FIGS. 3-5 also includes a pair of thermistor cartridge fastener holes 111, a pair of heater cartridge fastener holes 108, a pair of heat sink fastener holes 104, a central conduit 103, and a through thermistor hole 121 for receiving cartridges 21a (from one side) and/or 21b (from the opposite side). In alternative embodiments such as that shown in FIG. 6, through hole (121) may receive one or more wire thermistors (20a and/or 20b). Heater block may include holes 120a and/or 120b for receiving a fastener 35 to hold a wire thermistor (20a or 20b) against block 100. For a dual thermistor embodiment, each pair of thermistors (20a, 20b or 21a, 21b) (not shown in FIGS. 3-5) should be between the heater cartridges (10a, 10b) (not shown in FIGS. 3-5).

To assemble the embodiments of FIGS. 1-6, a first heater cartridge 10a may be inserted into the first heater block conduit 110a and the second heater cartridge 10b may be inserted into the second heater block conduit 110b, respectively. Each heater cartridge (10a, 10b) may be secured to the heater block conduits 110a or 110b with a fastener 18 (for example and without limitation, a M3 set screw) that may be advanced into the heater cartridge fastener opening 108 to engage with the surface of each heater cartridge in the corresponding heater block conduit to provide a frictional holding force operable to secure the heater cartridges (10a, 10b). The central conduit opening 103 may extend through the heater block 100 and may have threading operable to secure the nozzle 19 to the bottom surface 100b and threading to secure the heat breaker 13 to the top surface 100t. A pair of heat sink fastener holes 104 may be operable to align a pair of bolts with the heater block 100 and the heat sink 14. The heat sink 14 may have a pair of threaded holes (not shown) that may be operable to receive threaded fasteners 24 that may be operable to secure the heat sink to the heater block 100. The heater block may have at least one thermistor conduit 121 to receive cartridge thermistors 21a and/or 21b from either side (as shown in FIGS. 1-2); and/or block 100 may have additional holes 120a and/or 120b for receiving fasteners 35 that hold wire thermistors 20a and/or 20b in conduit 121 (as shown in FIG. 6). If cartridge thermistors 21a and/or 21b are used, securing screws may be inserted into cartridge fastener holes 111 (as shown in FIG. 3) to hold the cartridge thermistors in place. The thermistors 20a, 20b, 21a, and/or 21b may be operable to measure the temperature of the heater block 100 and may be in electrical communication with a controller (not shown) that may be operable to adjust the temperature output of the heater cartridges (10a, 10b).

It is to be appreciated that in different embodiments, conduit 121 may not be a through hole, but may comprise separate openings 121a, 121b (not shown) that may be provided, respectively, on opposite sides of heater block 100. These separate openings 121a/121b may or may not be aligned with each other, and may or may not be on opposite sides of a central axis of the block 100. In such embodiments, a cartridge thermistor 21a may be inserted into opening 121a, and/or another cartridge thermistor 21b may be inserted into opening 121b on the opposite side of heater block 100. In these embodiments, attachment openings 120a/120b should be provided in close proximity to openings 121a, 121b to allow for the alternative use of wire thermistor(s) 20a and/or 20b, which may be inserted into openings 121a and/or 121b.

In some embodiments, there may be additional conduits and holes on the heater block 100. The conduits and holes may be operable to receive and secure a fan shroud or air nozzle for cooling the material that is extruded through the hot end assembly.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as may be suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A heater block for use in a hot end assembly of a 3D printer, the heater block comprising:
a. a body made from a thermally conductive material configured to evenly distribute heat throughout the body;
b. a first and a second aperture extending through the body for receiving a first and a second heater cartridge, the first and second apertures securing said heater cartridges in thermal contact with said body to heat the body;
C. at least one third aperture extending through the body for receiving at least one thermistor, such that after insertion, the thermistor is capable of measuring the temperature of said body; and
d. a central conduit extending through the body for receiving a heat break on a top surface of said body, the central conduit configured to guide a filament from an extruder to a nozzle secured to a bottom surface of said body; wherein said nozzle is in thermal contact with the body and is positioned between said first and second heater cartridges, and is operable to provide heat for melting the filament.

2. The heater block of claim 1, wherein said at least a third aperture is provided between said first and second apertures.

3. The heater block of claim 1, wherein said first and second apertures extend from one side of said body to an opposite side of said body.

4. The heater block of claim 3, wherein the top surface of said body comprises a first threaded hole in communication with said first aperture, and a second threaded hole in communication with said second aperture.

5. The heater block of claim 4, wherein said first threaded hole is operable to receive a first fastener that is operable to secure the first heater cartridge the first aperture, and said second threaded hole is operable to receive a second fastener that is operable to secure the second heater cartridge the second aperture.

6. The heater block of claim 5, wherein said first and second heater cartridges each have a heating output monitored by said at least one thermistor.

7. The heater block of claim 1, wherein said at least one third aperture comprises two apertures, and said at least one thermistor comprises two thermistors, each thermistor positioned in one of said two third apertures, wherein said two thermistors are operable to independently measure a temperature of said body adjacent to each of said first and second heater cartridges.

8. The heater block of claim 1, wherein said heat break and said nozzle are in axial alignment in said central conduit.

9. The heater block of claim 1 wherein said at least one thermistor is a cartridge thermistor.

10. The heater block of claim 1 wherein said at least one thermistor is a wire thermistor.

11. A method of using a heater block in a hot end assembly of a 3D printer, the method comprising the steps of:
a. inserting a first heater cartridge into a first aperture of the heater block, wherein said first heater cartridge is in thermal contact with said heater block;
b. inserting a second heater cartridge into a second aperture of the heater block, wherein said second heater cartridge is in thermal contact with said heater block;
c. inserting at least one thermistor into a third aperture of said heater block that is between said first and second apertures of said heater block, wherein said thermistor is operable to measure a temperature of said heater block;
d. providing a central conduit in said heater block and inserting a heat break into said central conduit on a top surface of said heater block and inserting a nozzle into said central conduit on a bottom surface of said heater block, wherein said heat break and said nozzle are in axial alignment and are in thermal contact with the heater block; and
e. applying electrical power to said first and second heater cartridges to generate heat, thereby heating the heater block and nozzle.

12. The method of claim 11, wherein said first and second heater cartridges have a distal end having wiring that is in communication with a controller, and said first and second heater cartridges are operable to convert electrical power into heat.

13. The method of claim 12, wherein said central conduit is positioned between said first and second heater cartridges and is operable to provide a uniform heat distribution to each side of said nozzle.

14. The method of claim 12, further comprising
a. monitoring the temperature of said heater block with said at least one thermistor and adjusting the power to each of said heater cartridges to maintain a desired temperature;
b. feeding a filament through said heat break into said nozzle, wherein the heat from said heater block melts the filament; and
c. extruding a melted filament through said nozzle onto a build plate of the 3D printer to create a 3D object.

15. The method of claim 14, wherein said at least one thermistor is operable to monitor the temperature of the entire heater block and may be operable to provide temperature data to said controller for modifying the temperature of said first and second heater cartridges.

16. The method of claim 15, wherein said at least one thermistor comprises two thermistors, each positioned adjacent to one of said first and second apertures, each being operable of independently measuring a temperature of said heater block adjacent to each of said apertures.

17. The method of claim 16, wherein any variation of temperature received from said first and second thermistors is operably adjusted by said controller to provide a uniform heat distribution in said heater block.

18. A hot end assembly for a 3D printer, comprising:
a. a nozzle through which a filament is extruded;
b. a heater block having a central conduit therein for securing said nozzle on a bottom surface thereof, said block having first and second heater cartridge apertures therein located on opposite sides of said central conduit, wherein said nozzle is in thermal contact with said heater block;
c. a heat break connecting said heater block to a heat sink, said heat break being secured to a top surface of said heater block, wherein said heater block is operable to guide said filament from an extruder to said nozzle;
d. a first heater cartridge secured to said first heater cartridge aperture and a second heater cartridge secured to said second heater cartridge aperture, wherein each of said heater cartridges may be operable to heat said heater block; and
e. at least one centrally located thermistor in said heater block for monitoring a temperature of said heater block.

19. The hot end assembly of claim 18, further comprising a guide tube secured to a top end of said heat break, the guide tube being operable to route said filament into said heat break.

20. The hot end assembly of claim 18, wherein each of said first and second heater cartridges is monitored by two thermistors, each positioned adjacent to one of said heater cartridges in said heater block, wherein each thermistor is operable to measure a temperature of each heater cartridge.
